(19) United States
(12) Patent Application Publication
(10) Pub. No.: US 2020/0087041 A1
(43) Pub. Date: Mar. 19, 2020

(54) COMPRESSED GAS SUPPLY DEVICE

(71) Applicant: CNG CO., LTD., Chungcheongbuk-do (KR)

(72) Inventor: Sungjin JANG, Seoul (KR)

(21) Appl. No.: 16/470,573

(22) PCT Filed: Nov. 21, 2017
(86) PCT No.: PCT/KR2017/013285

§ 371 Date: Jun. 18, 2019

(30) Foreign Application Priority Data
Dec. 22, 2016 (KR) 10-2016-0176520

(51) Int. Cl. B65D 51/28; B65D 41/04; A23L 2/54; B01F 3/04

(52) U.S. Cl. CPC B65D 51/2814; B65D 41/04; B01F 2215/0022; B01F 3/04801; A23V 2002/00; A23L 2/54

(57) ABSTRACT

The present invention relates to a compressed gas supply device. More specifically, the compressed gas supply device includes: a cover; a body configured to accommodate a gas container containing a compressed gas therein and to be installed at an open inlet portion of a food container containing a liquid; a discharging means provided in the body for discharging the compressed gas into the food container by opening the gas container; a coupling means configured to couple the cover to the body; and a sealing jaw formed in the body to prevent the liquid of the food container from being exhausted to the outside by contacting the inlet portion of the food container.

### BACKGROUND

### 1. Technical Field

The present invention relates to a compressed gas supply device.

### 2. Description of Related Art

In general, oxygen is a gas that is indispensable to human life, not only for breathing but also for decomposing various fatigue materials, facilitating metabolism, improving muscle and cardiopulmonary function.

This oxygen has recently been shown in clinical trials to promote the digestive action of the liver and the secretion of digestive enzymes when drinking high-concentrated oxygenated water, and thus there is a growing interest in products that allow oxygen to be dissolved in water, alcohol, and cosmetics in high concentrations.

However, in the case of fruit drinks, ordinary water or carbonated beverages, they are stored and stored in beverage containers made of glass bottles or plastic materials, while a device for injecting oxygen into the container cannot be provided in order to maintain a high concentration of dissolved oxygen and to facilitate blood circulation and metabolism in the human body.

Accordingly, as disclosed in Korean Patent Registration No. 10-1622949, a technology has been developed in which oxygen is supplied to a food container through a compressed gas supply device to increase an amount of dissolved oxygen.

However, even when water having a high dissolved oxygen amount is contained in a container, oxygen is discharged during the process of sealing the container to lower the dissolved oxygen amount, and when oxygen is separated from water by an external impact in the process of being transported in a sealed state and the container is unsealed, the separated oxygen is discharged to the outside and thus cannot maintain the initial dissolved oxygen amount, thereby reducing the effect significantly.

In addition, the conventional compress gas supply device cannot accurately recognize when the gas container is opened by a discharging means, and a gas such as oxygen contained in the gas container is discharged to the inside of the food container at an unexpected time.

Further, the conventional compressed gas supply device has a sealing degree depending on the length of an inlet portion of the food container when the supply device closes and seals with the inlet portion of the food container, and as a result, when the compressed gas is discharged into the food container, a liquid flows backward and is ejected outward.

Finally, the conventional compressed gas supply device may not visually accurately recognize that the compressed gas is discharged into the food container, due to ambient environment such as lightness.

### SUMMARY

A technical object of the present invention is to provide a compressed gas supply device that is capable of easily supplying a compressed gas into a food container and easily dissolving the gas in a liquid, thereby increasing a dissolution rate of the liquid.

Another technical object of the present invention is to provide a compressed gas supply device that is capable of allowing a user to precisely recognize that a gas container is opened and is in a step before a compressed gas is discharged into the food container when the user uses the compressed gas supply device.

Another technical object of the present invention is to provide a compressed gas supply device that is capable of preventing a liquid from flowing backward by providing complete sealing regardless of the length of an inlet portion of the food container when the compressed gas supply device is coupled and sealing with the inlet portion of the food container.

Another technical object of the present invention is to provide a compressed gas supply device that is capable of allowing a user to visually recognize a process of discharging a compressed gas regardless of ambient environment by illuminating the compressed gas supply device when the compressed gas supply device discharges the compressed gas into the food container.

To solve the above problems, an aspect of the present invention features a compressed gas supply device including: a cover; a body configured to accommodate a gas container containing a compressed gas therein and to be installed at an open inlet portion of a food container containing a liquid; a discharging means provided in the body for discharging the compressed gas into the food container by opening the gas container; a coupling means configured to couple the cover to the body; and a sealing jaw formed in the body to prevent the liquid of the food container from being exhausted to the outside by contacting the inlet portion of the food container.

In addition, the body may be formed with an installation space for positioning the inlet portion between the outer body and the inner body, and the sealing jaw may be formed to protrude downward at an upper end of the installation space to come into contact with an upper end of the inlet portion.

Further, the sealing jaw may have elasticity.

Another aspect of the present invention features a compressed gas supply device including: a cover; a body configured to accommodate a gas container containing a compressed gas therein and to be installed at an open inlet portion of a food container containing a liquid; a discharging means provided in the body for discharging the compressed gas into the food container by opening the gas container; an operating means configured to pressurize the gas container to be opened by the discharging means while moving the cover in a state being engaged with the body; and a recognizing means provided in the operating means for confirming that the gas container is in a state before being opened by the discharging means.

In addition, the recognizing means may be a protrusion.

The compressed gas supply device may further include an installation space provided in the body for positioning the inlet portion of the food container; and a sealing jig configured to protrude downward from the upper end of the installation space and to have a length that varies depending on a length of the inlet portion to seal the inlet portion of the food container.

Another aspect of the present invention features a compressed gas supply device including: a compressed gas supply device including: a cover; a body configured to accommodate a gas container containing a compressed gas therein and to be installed at an open inlet portion of a food container containing a liquid; a discharging means provided in the body for discharging the compressed gas into the food container by opening the gas container; an operating means configured to pressurize the gas container to be opened by the discharging means while moving the cover in a state being engaged with the body; an installation space provided in the body for positioning the inlet portion of the food container; and a sealing jig configured to protrude downward from the upper end of the installation space and to have a length that varies depending on a length of the inlet portion to seal the inlet portion of the food container.

In addition, a spring may be provided between the installation space and a sealing jaw.

The compressed gas supply device may further include a check valve disposed inside the discharging means to allow a flow of the compressed gas in one direction from the gas container to the food container and to block a flow in an opposite direction.

In addition, the check valve may include a piston configured to open or close the injection hole and to move by a pressure difference between opposite ends; and a guide portion configured to support the piston such that the piston can reciprocate toward the injection hole.

the guide portion may include: a first engagement member coupled to the piston; and a second engagement member slidably engaged with the first engagement member, And one of the first engagement member and the second engagement member may be formed with a groove and the other may be slidably inserted into the groove.

The compressed gas supply device may further include a lighting unit coupled to a lower end of the discharging unit and responsive to a pressure of the discharged gas.

The sealing jaw and the body may be in contact with and coupled to the inlet portion to withstand an internal pressure of the food container when the compressed gas is discharged into the food container.

### Advantageous Effects

As described above, the compressed gas supply device of the present invention has an effect of easily supplying a compressed gas into a food container and easily dissolving the gas in a liquid, thereby increasing a dissolution rate of the liquid.

In addition, the compressed gas supply device of the present invention has an effect of allowing a user to precisely recognize that a gas container is opened and is in a step before a compressed gas is discharged into the food container when the user uses the compressed gas supply device.

The compressed gas supply device of the present invention has an effect of preventing a liquid from flowing backward by providing complete sealing regardless of the length of an inlet portion of the food container when the compressed gas supply device is coupled and sealing with the inlet portion of the food container.

In addition, the compressed gas supply device of the present invention has an effect of allowing a user to visually recognize a process of discharging a compressed gas regardless of ambient environment by illuminating the compressed gas supply device when the compressed gas supply device discharges the compressed gas into the food container.

### BRIEF DESCRIPTION OF THE DRAWINGS

FIG. 1 illustrates a compressed gas supply device according to an exemplary embodiment of the present invention.

FIG. 2 illustrates a cross-sectional view of a compressed gas supply device according to an exemplary embodiment of the present invention.

FIG. 3 illustrates an operating means of a compressed gas supply device according to an exemplary embodiment of the present invention.

FIG. 4A, FIG. 4B, FIG. 4C and FIG. 4D illustrate operation states of an operating means and a recognizing means of a compressed gas supply device according to an exemplary embodiment of the present invention.

FIG. 5 illustrates a vibration preventing unit of a compressed gas supply device according to an exemplary embodiment of the present invention.

FIG. 6 illustrates a vibration preventing unit of a compressed gas supply device according to another exemplary embodiment of the present invention.

FIG. 7 illustrates schematic views of a discharging means of a compressed gas supply device according to an exemplary embodiment of the present invention.

FIG. 8 schematically illustrates an operating state of a discharging means of a compressed gas supply device according to an exemplary embodiment of the present invention.

FIG. 9 illustrates a discharging unit of a compressed gas supply device according to another exemplary embodiment of the present invention.

FIG. 10 illustrates a state in which a discharging pipe is provided in a compressed gas supply device according to an exemplary embodiment of the present invention.

FIG. 11 is views for illustrating how a degree of sealing between a compressed gas supply device and a food container is varied depending on the length of an inlet portion of the food container according to an exemplary embodiment of the prevention.

FIG. 12A, FIG. 12B, FIG. 12C and FIG. 12D illustrate an operation state of a sealing jaw of a compressed gas supply device according to an exemplary embodiment of the present invention.

FIG. 13 illustrates a state in which an outflow preventing unit is further formed in a compressed gas supply device according to an exemplary embodiment of the present invention.

FIG. 14 illustrates a state in which an exhaust unit is further formed in a compressed gas supply device according to an exemplary embodiment of the present invention.

FIG. 15 illustrates a schematic view of a compressed gas supply device according to another exemplary embodiment of the present invention.

FIG. 16 illustrates an operation state of a recognizing means of a compressed gas supply device according to another exemplary embodiment of the present invention.

### DETAILED DESCRIPTION OF THE INVENTION

The present invention is intended to illustrate the bars, reference to specific embodiments which may have a number of embodiments can be applied to various changes and describes them in detail from the following detailed description. This, however, is by no means to restrict the invention to the specific embodiments, it is to be understood as embracing all included in the spirit and scope of the present invention changes, equivalents and substitutes.

Terms including ordinal numbers such as first, second, and the like will be used only to describe various components, and are not to be interpreted as limiting these components. The terms are only used to differentiate one component from other components.

It is to be understood that when one component is referred to as being “connected” or “coupled” to another component, it may be connected or coupled directly to the other component or be connected or coupled to the other component with a further component intervening therebetween. On the other hand, it is to be understood that when one component is referred to as being “connected or coupled directly” to another component, it may be connected to or coupled to the other component without another component intervening therebetween.

It is also to be understood that the terminology used herein is only for the purpose of describing particular embodiments, and is not intended to be limiting of the invention. Singular forms are to include plural forms unless the context clearly indicates otherwise. It will be further understood that terms “comprises” or “have” used in the present specification specify the presence of stated features, numerals, steps, operations, components, parts, or a combination thereof, but do not preclude the presence or addition of one or more other features, numerals, steps, operations, components, parts, or a combination thereof.

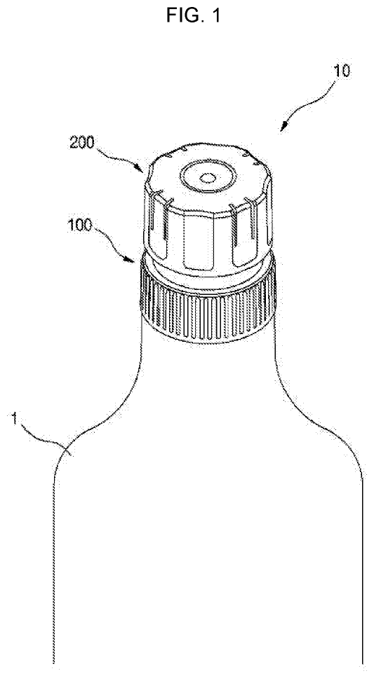

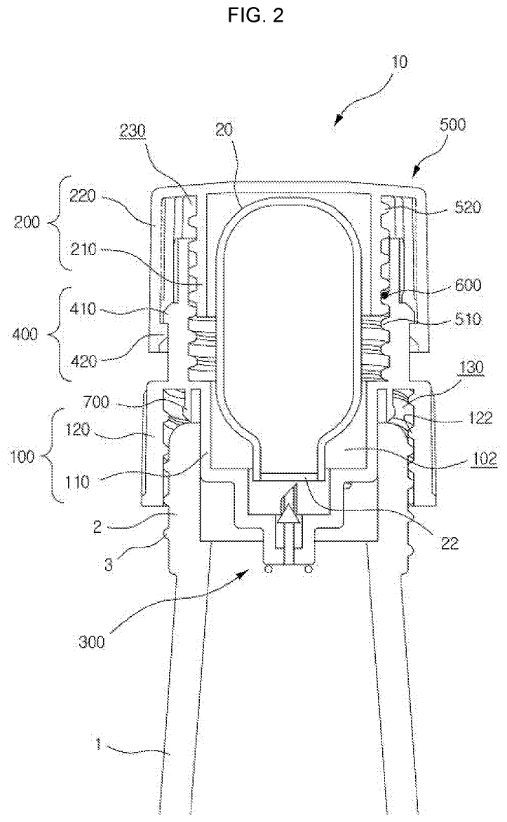

FIG. 1 illustrates a compressed gas supply device according to an exemplary embodiment of the present invention, and FIG. 2 illustrates a cross-sectional view of a compressed gas supply device according to an exemplary embodiment of the present invention.

Referring to FIG. 1 and FIG. 2, a compressed gas supply device 10 according to the present exemplary embodiment includes a body 100, a cover 200, a discharging means 300, a coupling means 400, an operating means 500, a recognizing means 600, and a sealing jaw 700.

When a food container 1 containing a liquid is manufactured to be circulated, the compressed gas supply device 10 is manufactured in a state of being installed in an inlet portion 2 of the food container 1, such that a step of removing a lid (not illustrated) blocking the inlet portion 2 may be omitted to provide convenience to users. On the other hand, they may be manufactured in a separated state.

To this end, the inlet portion 2 of the food container 1 is formed with a thread 3 along an external circumferential surface thereof, and the body 100 is also formed with a thread 122 corresponding to the thread 3 of the inlet portion 2 such that they are coupled to each other to close the inlet portion 2 of the food container 1.

The body 100 has an accommodating space 102 therein, and is installed in the opened inlet portion 2 of the food container 1 in which the liquid is contained.

The body 100 includes an inner body 110 and an outer body 120.

The inner body 110 forms the accommodating space 102, which is opened upward, and is inserted into the inlet portion 2 of the food container 1.

The outer body 120 has the thread 122 corresponding to the thread 3 of the inlet portion 2, and an installation space 130 is formed between a middle portion of the inner body 110 and a lower portion thereof, to position the inlet portion 2 therebetween.

The thread 122 of the outer body 120 is coupled to the thread 3 of the inlet portion 2 to couple the body 100 to the food container 1.

The gas container 20 is closed by a stopper 22 after a compressed gas is contained therein, to be accommodated in the accommodating space 102. Herein, the compressed gas contained in the gas container 20 is mainly oxygen, and another gas may be compressed to be contained therein in some cases.

The gas container 20 is used in a one-time manner by coupling the cover 200 thereto in a state of being accommodated in the accommodating space 102 of the body 100. In addition, the gas container 20 may be detachably provided.

In other words, one side portions of the body 100 and the cover 200 coupled to each other may be opened to open one side of the accommodating space 102, such that the gas container 20 can be replaced.

The cover 200 is provided to prevent escaping of the gas container 20 accommodated in the accommodating space 102 of the body 100, to be coupled to the body 100 by the coupling means 400.

The cover 200 includes an inner cover 210 and an outer cover 220.

The inner cover 210 is inserted inward to close the accommodating space 102 of the inner body 110, and the outer cover 220 is formed with a coupling space 230 to position an upper end of the inner body 110 between the inner cover 210 and the outer cover 220.

The discharging means 300 is provided in the body 100 to open the stopper 22 of the gas container 20 to discharge the compressed gas into the food container 1.

The coupling means 400 couples the body 100 with the cover 200.

The coupling means 400 includes a first coupling protrusion 410 and a second coupling protrusion 420.

The first coupling protrusion 410 is formed to protrude along an external circumference of the upper end of the inner body 110, and the second coupling protrusion 420 is formed to protrude along an outer circumference of the outer cover 220 to correspond to the first coupling protrusion 410.

For an operating state of the coupling means 400, when the cover 200 is coupled to the body 100, the cover 200 is coupled to the body 100 by allowing the second coupling protrusion 420 to externally slide along the first coupling protrusion 410 to be coupled thereto.

Herein, each of the first and second coupling protrusions 410 and 420 may be formed to have a cross-section that has one of semicircular, semi-elliptical, triangular, and right triangular shapes, but may preferably be formed to have a saw-tooth right triangular cross-section to prevent reverse separation of the cover 200 coupled to the body 100.

In other words, each of the first and second coupling protrusions 410 and 420 may be formed to have any shaped cross-section that is capable of preventing easy separation of the coupled state due to formation of inclined surfaces and right-angled surfaces.

The first coupling protrusion 410 is formed to protrude along the outer circumference of the upper end portion of the inner body 110 formed at the middle portion of the inner body 110, and a lower end portion of the cover 200 that is coupled to the body 100 by the coupling means 400 is spaced apart from an upper end of the outer body 120 by a predetermined distance.

The spaced-apart portion may allow the cover 200 to move downwardly by the operating means 500 to pressurize the accommodated gas container 20 downward to discharge the gas.

The operating means 500 rotates the cover 200 coupled to the body 100 by the coupling means 400 in only one direction to press the gas container 20 to the discharging means 300, and rotates the cover 200 in an opposite direction to be separated from an inlet of the food container 1 together with the body 100.

The operating means 500 includes a first operating thread 510 and a second operating thread 520.

The first actuating thread 510 is formed in the accommodating space 102 of the inner body 110 and the second operating thread 520 is formed along the external circumference of the inner cover 210 to correspond to the first operating thread 510.

The recognizing means 600 may allow a user to recognize that the gas container 20 is in a state before it is discharged by the discharging means 130. Specifically, the recognizing means 600 may be formed as a protrusion along an external circumference of at least one of the first operating thread 510 and the second operating thread 520.

The sealing jaw 700 is formed to protrude downward from an upper end portion of the installation space 130 so as to come into contact with an upper end of the inlet portion 2 of the food container 1.

The sealing jaw 700 is brought into contact with the inlet portion 2 of the food container 1 to seal the food container 1 so as to prevent overflow of the liquid in the food container 1 even when the compressed gas is discharged to the food container 1 to increase an internal pressure of the food container 1.

The sealing jaw 700 may be implemented by using at least one of the methods of providing elasticity and varying a length of the protrusion corresponding to the length of the inlet portion 2 of the food container 1.

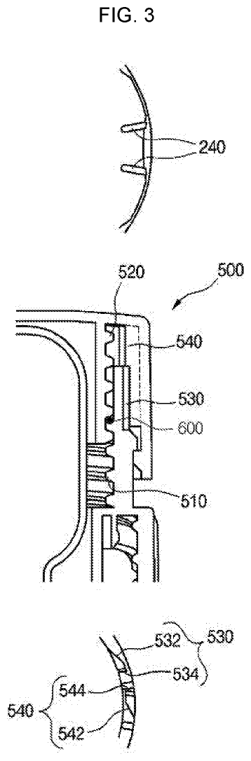

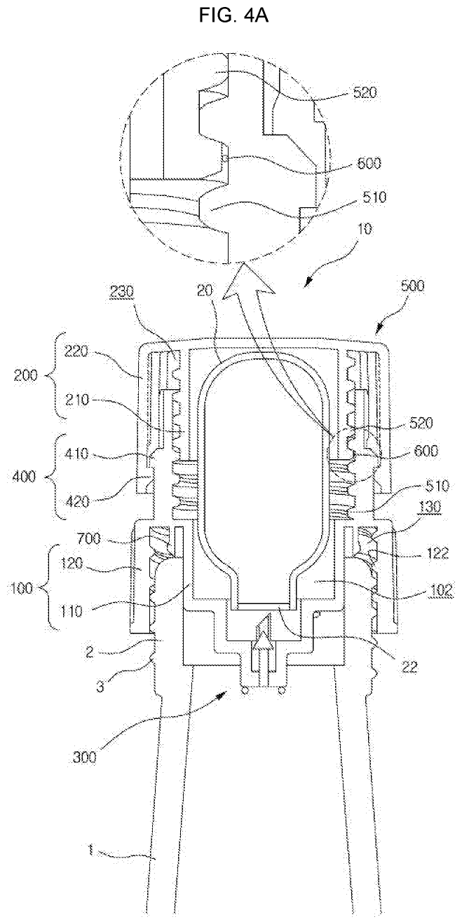

FIG. 3 illustrates an operating means of a compressed gas supply device according to an exemplary embodiment of the present invention.

Referring to FIG. 3, the operating means 500 further includes a first operating tooth 530 and a second operating tooth 540.

The first operating tooth 530 includes a first vertical surface 534 and a first inclined surface 532 which are formed at a regular interval along the external circumference of the upper end of the inner body 110, the first vertical surface 534 is formed in parallel with an extension line passing a center point of the inner body 110, and the first inclined surface 532 is formed to be inclined at a certain angle with respect to the extension line.

The second operating tooth 540 includes a second inclined surface 542 that is formed along an internal circumference of the outer cover 220 so as to correspond to the first operating tooth 530 and contacts the first inclined surface 532 of the first operating tooth 530 to slide in one direction, and a second vertical surface 544 that is formed to prevent it from rotating a different direction due to the first vertical surface 534 of the first operating tooth 530.

Herein, the outer cover 220 is formed with a cutout groove 240 along at least one side edge on which the second operating teeth 540 are formed.

The cutout groove 240 is formed to provide flexibility and elasticity to allow the second operating tooth 540 to move outward when the second operating tooth 540 slides along the first operating tooth 530, and provides the flexibility when the second inclined surface 542 slides along the first inclined surface 532 of the first operating tooth 530.

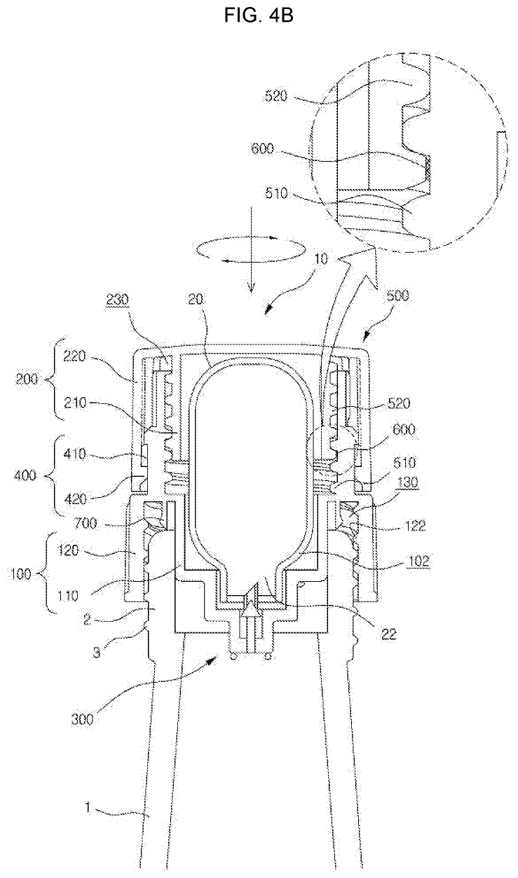

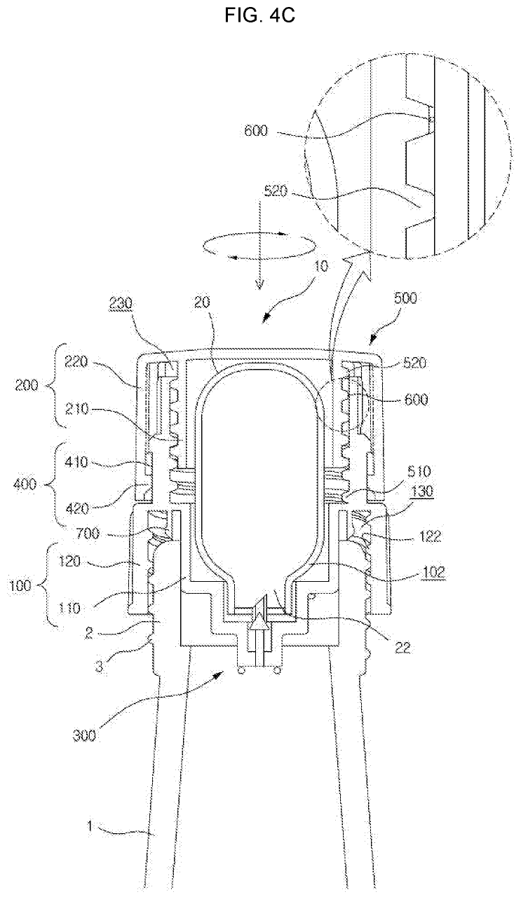

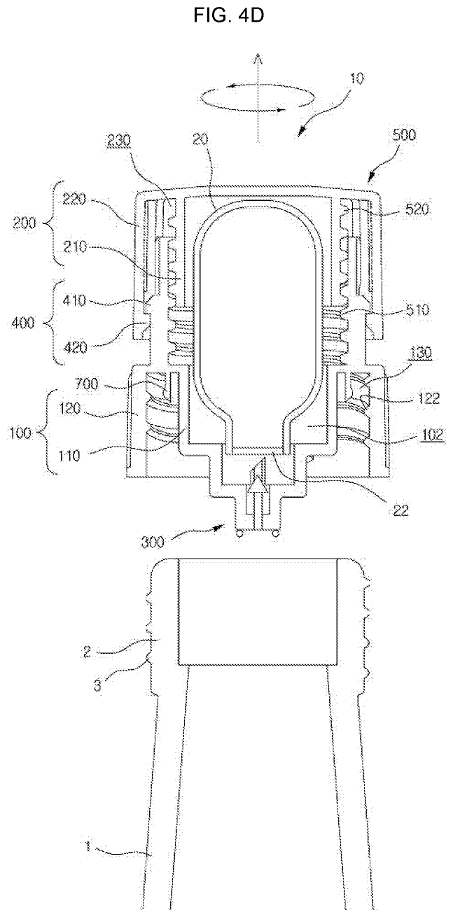

FIG. 4A, FIG. 4B, FIG. 4C and FIG. 4D illustrate operation states of an operating means and a recognizing means of a compressed gas supply device according to an exemplary embodiment of the present invention.

Referring to FIG. 4A, the gas container 20 is accommodated in the accommodating space 102, and the second coupling protrusion 420 slides along the first coupling protrusion 410 to be coupled thereto, whereby the cover 200 is coupled to the body 100.

In this state, the cover 200 is not in contact with an upper portion of the gas container 20, the gas container 20 is not in contact with the discharging means 300 due to the cover 200, and the cover 200 is not in contact with the recognizing means 600.

Referring to FIG. 4B, FIG. 4B illustrates a state in which the cover 200 moves along the body 200 by the operating means 500 to contact the recognizing means 600.

In this state, as the second operating thread 520 moves in combination with the first operating thread 510, the recognizing means 600 formed in the first operating thread 510 and the second operating thread 520 contact each other, so that a user feels a vibration by the recognizing means 600 to recognize that the gas container 20 is in a state before being discharged by the discharging means 300.

Referring to FIG. 4C, FIG. 4C illustrates a state in which the cover 200 moves along the body 100 by the operating means 500 to pressurize the gas container 20 such that the compressed gas inside the gas container 20 is discharged by the discharging means 300.

In this state, the cover 200 moves to the body 100 through the recognizing means 600 to pressurizes the gas container 20, whereby the compressed gas inside the gas container 20 is discharged by the discharging means 300.

Then, the second vertical surface 544 of the second operating tooth 540 is caught by the first vertical surface 534 of the first operating tooth 530 to prevent the cover 200 from rotating in the opposite direction.

Referring to FIG. 4D, FIG. 4D illustrates a state in which the compressed gas supply device 10 is removed from the food container 1.

In this state, when the cover 200 is rotated at a predetermined pressure or more in the opposite direction after the discharge of the compressed gas is completed, the body 100 is also rotated by the second vertical surface 544 and the first vertical surface 542 which contact each other to be removed from the food container 1.

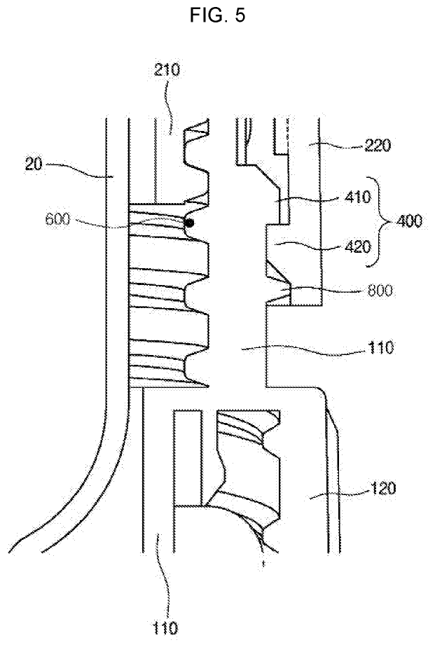

FIG. 5 illustrates a vibration preventing unit of a compressed gas supply device according to an exemplary embodiment of the present invention.

Referring to FIG. 5, a vibration preventing unit 800 for preventing the cover 200 coupled to the body 100 by the coupling means 400 from being vibrated is further included.

The vibration preventing unit 800 is formed to protrude from the inner body 110 and pressurizes the outer cover 220 outwardly to prevent the cover 200 from vibrating in the body 100.

The vibration preventing unit 800 is formed between the first coupling means 410 and the inner body 110 in which the outer body 120 is formed to be strongly fitted into a gap with the outer cover 220, such that the outer cover 220 is outwardly pressurized to prevent the vibration thereof.

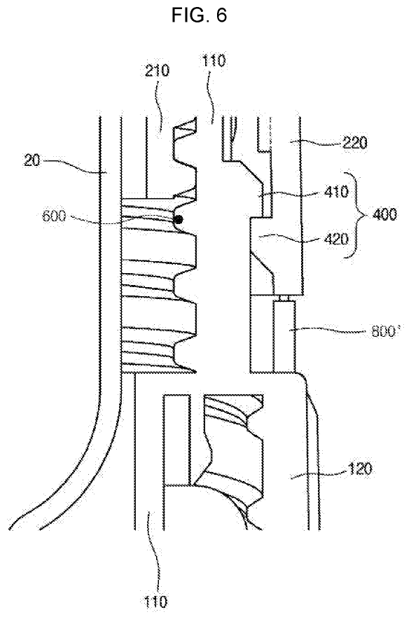

FIG. 6 illustrates a vibration preventing unit of a compressed gas supply device according to another exemplary embodiment of the present invention.

Referring to FIG. 6, a vibration preventing unit 800′ is formed at a lower end portion of the outer cover 220 so as to be in contact with an upper end portion of the outer body 120, and is detachable.

The vibration preventing unit 800′ is connected to a lower end of portion of the outer cover 220 by a perforated line (not illustrated), and may be separated from a lower end portion of the outer cover 220, if necessary.

In other words, the vibration preventing unit 800′ prevents the cover 200 coupled by the coupling means 400 from vibrating in the body 100 when the compressed gas supply device 10 is not used.

As the vibration preventing unit 800′ is separated from the outer cover 220 to be removed when the compressed gas supply device 10 is used, a space is provided such that the cover 200 may be rotated in one direction to move downward.

Thus, the cover 200 may pressurize the gas container 20 by the discharging means 300 to discharge the compress gas.

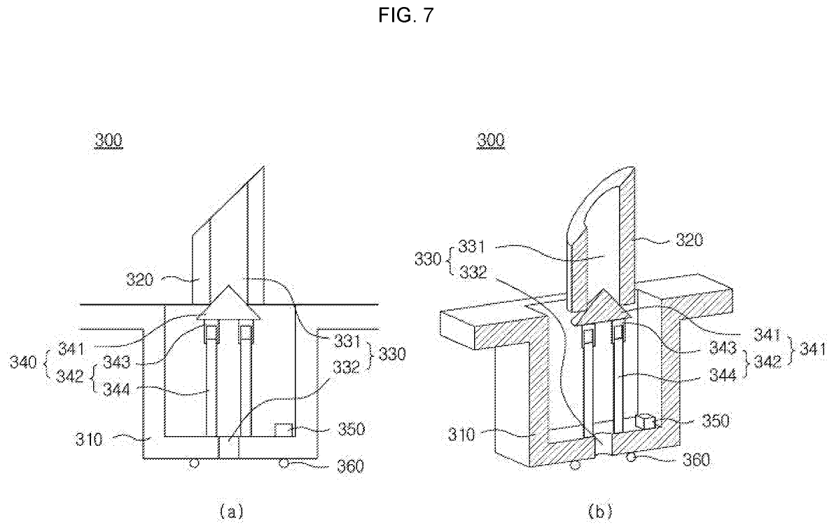

FIG. 7 illustrates schematic views of a discharging means of a compressed gas supply device according to an exemplary embodiment of the present invention.

In FIG. 7, (a) illustrate a perspective view of the discharging means 300 of the compressed gas supplying device 10, and (b) illustrates an exploded view of the discharging means 300 of the compressed gas supply device 10.

Referring to (a) and (b) in FIG. 7, the discharging means 300 includes a discharging body 310, a needle 320, an injection hole 330, a check valve 340, a switch 350, and a lighting unit 360.

The discharging body 310 is integrally formed with the body 100, and an interior thereof is empty.

The needle 320 protrudes from the discharging body 310 toward the cover 200 to pierce the stopper of the gas container 20.

The injection hole 330 is formed to include a first injection hole 331 and a second injection hole 332.

The first injection hole 331 is formed inside the needle 320 to extend therethrough, and the second injection hole 332 is formed at one side of an inner lower portion of the discharging body 310 to extend therethrough, and thus the compressed gas in the gas container 20 passes through the first injection hole 331 to the inside of the discharging body 310, and is discharged through the second injection hole 332 to be injected into the food container 1.

The check valve 340 is disposed inside the discharging body 310 to allow a flow of gas compressed in one direction to pass from the gas container 20 to the food container 1 and block a flow in the opposite direction.

The check valve 340 includes a piston 341 and a guide portion 342.

The piston 341, which has a shape that widens from an upper portion thereof to a lower portion thereof, is disposed at a lower portion of the first injection hole 331 to open or close the first injection hole 331, and moves by a pressure difference between the first injection hole 331 and the second injection hole 332.

The guide portion 342 supports the piston 341 such that the piston 341 can reciprocate through the first injection hole 331.

The guide portion 342 includes a first engagement member 343 and a second engagement member 344.

The first engagement member 343 protrudes from a bottom surface of the piston 341.

The second engagement member 344 is formed at one side of an inner lower portion of the discharging body 310 to protrude corresponding to the first engagement member 343 so as to be slidably engaged with the first engagement member 343.

In this case, one of the first engagement member 343 and the second engagement member 344 is formed with a groove, and the other is slidably inserted into the groove.

In addition, a length of the groove formed in any of the first engagement member 343 and the second engagement member 344 is longer than a movement distance of the piston 341.

The switch 350 is installed at one side of an inner bottom surface of the discharging body 310 to operate the lighting unit 360 in response to the pressure.

The lighting unit 360 is formed at a lower portion of the discharging body 310 to receive an operation signal from the switch 350 in response to a pressure generated when the compressed gas of the gas container 20 is ejected, to turn on a light such that the compressed gas is ejected into the food container 1 can be visible, and in the case of no ejection, the light is automatically turned off since it does not receive operation signal from the switch 350.

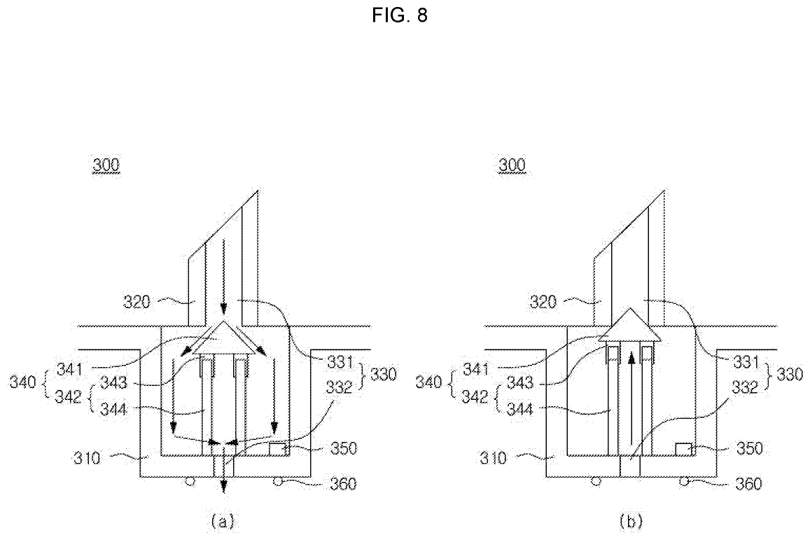

FIG. 8 schematically illustrates an operating state of an injecting means of a compressed gas supply device according to an exemplary embodiment of the present invention.

In FIG. 8, (a) illustrates a case in which the gas container 20 is opened by the discharging means 300 and the compressed gas is ejected, and (b) illustrates a case in which a gas flows backward since the compressed gas is supplied into the food container 1 to increase the pressure.

Referring to (a) in FIG. 8, when the gas container 20 is opened by the needle 320 of the discharging device 300, the compressed gas is ejected, and when the pressure of the compressed gas is transferred to the piston 341, the first engagement member 343 disposed at a lower portion of the piston 341 slides along the second engagement member 344 to move the piston 341 down, so that the first injection hole is opened to discharge the compressed gas into the discharging body 310, thereby injecting it into the food container 1 through the second injection hole 332.

The compressed gas discharged into the discharging body 310 pressurizes the switch 350 disposed at an inner bottom of the discharging body 310 to operate the lighting unit 360.

Referring to (b) in FIG. 8, when the gas flows backward into the discharging body 310 through the second injection hole 332 to transfer a pressure to the piston 341 that has moved down since the pressure of the food container 1 is increased by the compressed gas of the gas container 20 injected into the food container 1, the first engagement member 343 disposed at the lower portion of the piston 341 slides along the second engagement 344 toward the first injection hole 331 to move the piston 341 up such that the piston 341 blocks the first injection hole 331 to prevent the backflow.

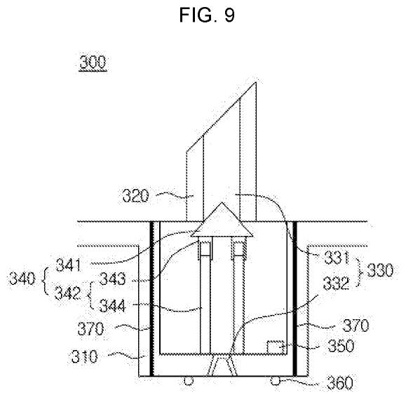

FIG. 9 illustrates an injecting unit of a compressed gas supply device according to another exemplary embodiment of the present invention.

Referring to FIG. 9, the discharging means 300 further includes an exhaust hole 370.

The exhaust hole 370 is formed in the discharging body 310 such that the gas of the gas container 20 is exhausted to the accommodating space 102. This exhaust hole 340 includes one or more exhaust holes 340.

The second injection hole 332 may include a plurality of divided injection holes.

The divided second injection holes 332 may discharge the compressed gas in a clockwise or counterclockwise direction to form a vortex such that the compressed gas can be easily supplied to a lower end portion of the liquid, thereby easily increasing an amount of dissolved gas.

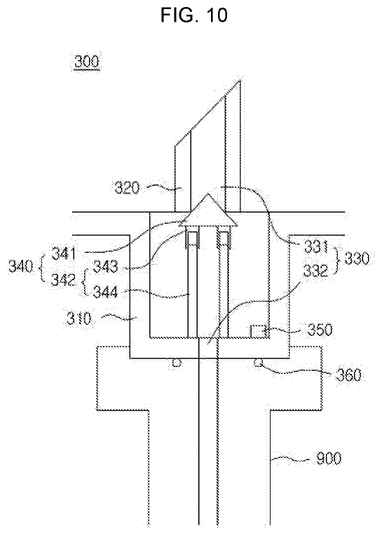

FIG. 10 illustrates a state in which an injection pipe is provided in a compressed gas supply device according to an exemplary embodiment of the present invention.

Referring to FIG. 10, an injection pipe 900 is formed to extend inside the food container 1, to discharge the compressed gas injected into the injection hole 330, at an inner lower end of the food container 1.

Thus, a time during which the compressed gas is in contact with the liquid may be increased, to increase the amount of dissolved gas.

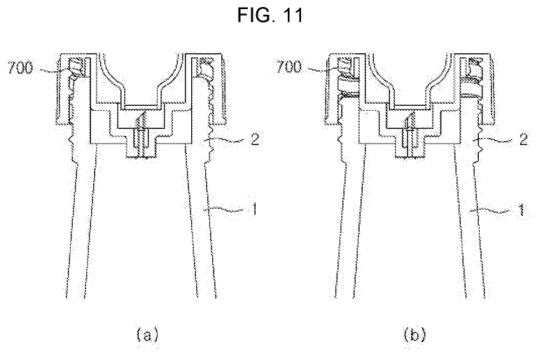

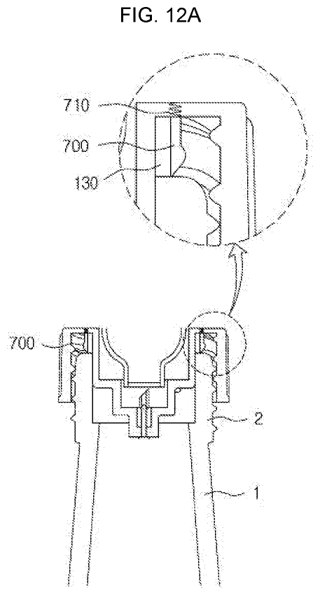

FIG. 11 is views for illustrating how a degree of sealing between a compressed gas supply device and a food container is varied depending on the length of an inlet portion of the food container according to an exemplary embodiment of the prevention.

In FIG. 11, (a) illustrates a state in which the sealing jaw 700 is long enough to be in contact with the inlet portion 2 of the food container.

Referring to (a) in FIG. 11, even when the compressed gas is discharged into the food container 1 by the discharging means 300 to increase the internal pressure of the food container 1, the liquid contained in the container 1 is primarily prevented from overflowing out of the food container 1 by the sealing jaw 700 contacting the inlet portion 2 of the food container 1.

Even when the liquid of the food container 1 flows over the sealing jaw 700, the body 100 coupled with the inlet portion 1 of the food container 1 is sealed, such that the liquid can be secondarily prevented from overflowing out of the food container 1.

In FIG. 11, (b) illustrates a state in which the inlet portion 2 of the food container 1 is too short to be in contact with the inlet portion 2 of the food container 1.

Referring to (b) in FIG. 11, when the internal pressure of the food container 1 is increased, only the body 100 cannot withstand the internal pressure of the food container 1, so that the liquid in the food container 1 may overflow the food container 1.

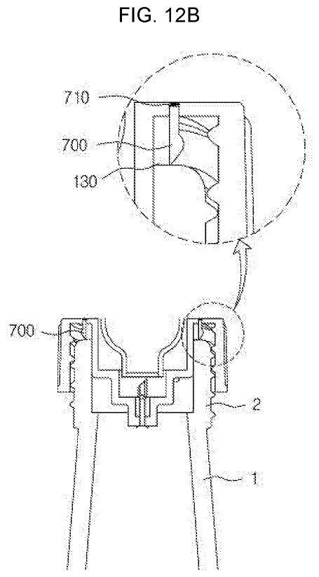

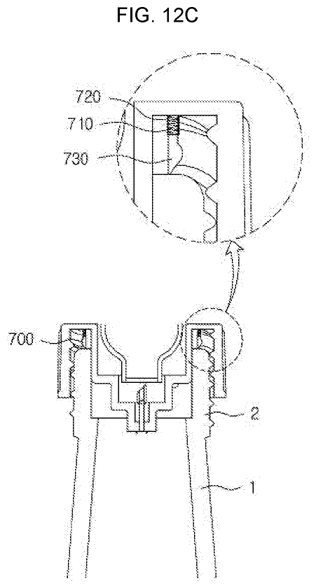

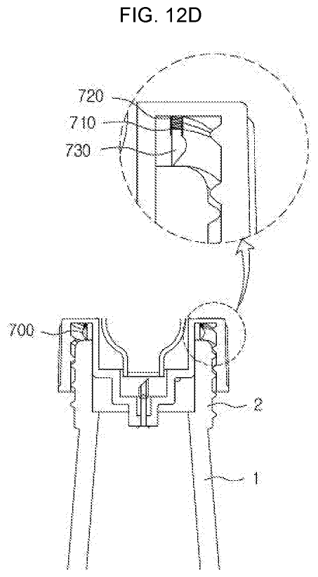

FIG. 12A, FIG. 12B, FIG. 12C and FIG. 12D illustrate an operation state of a sealing jaw of a compressed gas supply device according to an exemplary embodiment of the present invention.

FIG. 12A and FIG. 12B illustrate exemplary embodiments in which a groove is formed at one side of a lower end of the installation space 130 of the body 100 of the compressed gas supply device 10, a spring 710 is inserted into the groove, and the sealing jaw 700 is formed thereon to protrude.

FIG. 12A illustrates a case where the inlet portion 2 of the food container 1 has a short length, and FIG. 12B illustrates a case where the inlet portion 2 of the food container 1 has a long length.

Referring to FIG. 12A, when the inlet portion 2 of the food container 1 has the short length, it can be seen that the sealing jaw 700 is in contact with the inlet portion 2 by a pressure of the spring 710 in the groove.

Referring to FIG. 12B, when the inlet portion 2 of the food container 1 has a long length, when the body 100 is coupled to the inlet portion 2 of the food container 1, the sealing jaw 700 contacts the inlet portion 2 of the food container 1, so the spring 710 is pressed by the pressure to insert the sealing jaw 700 into the groove.

FIG. 12C and FIG. 12D illustrate exemplary embodiments in which the sealing jaw 700 formed at one side of the lower end of the installation space 130 of the body 100 of the compressed gas supply device 10 includes an upper sealing jaw 720 and a lower sealing jaw 730 as a dual structure, and the spring 710 is disposed inside the sealing jaw 720.

FIG. 12C illustrates a case where the inlet portion 2 of the food container 1 has a short length, and FIG. 12D illustrates a case where the inlet portion 2 of the food container 1 has a long length.

Referring to FIG. 12C, when the inlet portion 2 of the food container 1 has the short length, it can be seen that the lower sealing jaw 730 is in contact with the inlet portion 2 by a pressure of the spring 710 in the upper sealing jaw 720.

Referring to FIG. 12D, when the inlet portion 2 of the food container 1 has a long length, when the body 100 is coupled to the inlet portion 2 of the food container 1, the lower sealing jaw 730 contacts the inlet portion 2 of the food container 1, so the spring 710 is pressed by the pressure to insert the lower sealing jaw 730 into the upper sealing jaw 720.

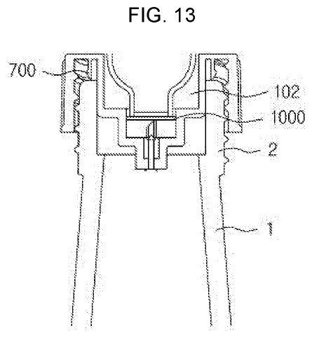

FIG. 13 illustrates a state in which an outflow preventing unit is further formed in a compressed gas supply device according to an exemplary embodiment of the present invention.

Referring to FIG. 13, the body 100 further includes an outflow preventing unit 1000 for preventing the liquid of the food container 1 from being exhausted to the outside.

The outflow preventing unit 1000 is formed at a lower end portion of the accommodating space 102 adjacent to the discharging means 300 to prevent the liquid of the food container 1 from moving to the accommodating space 102 through an injection hole 2.

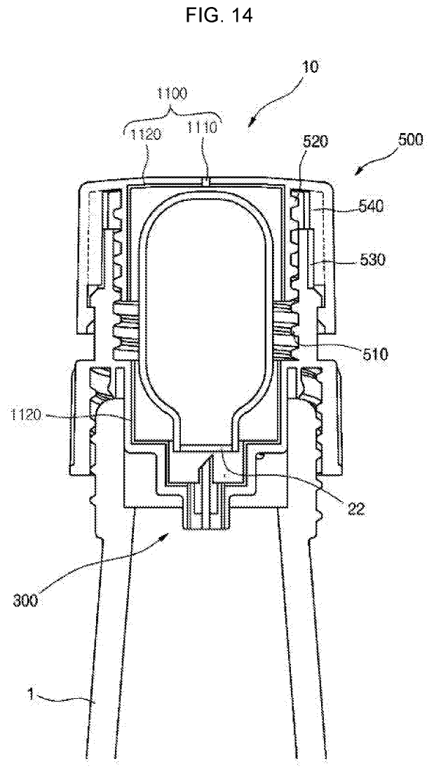

FIG. 14 illustrates a state in which an exhaust unit is further formed in a compressed gas supply device according to an exemplary embodiment of the present invention.

An exhaust unit 1100 is provided for exhausting the gas in the accommodating space 102 to the outside.

The exhaust unit 1100 includes an exhaust hole 1110 and a guide groove 1120.

The exhaust hole 1110 is formed in the cover 200 such that the accommodating space 102 communicates with the outside, and the guide groove 1120 is formed on an inner surface of the accommodating space 102 and an inner surface of the cover 200.

Accordingly, the gas contained in at least one of the accommodating space 102 and the food container 20 may be easily exhausted to the outside through the guide groove 1120 and the exhaust hole 1110, thereby preventing the food container 20 from broken by the supplied compressed gas.

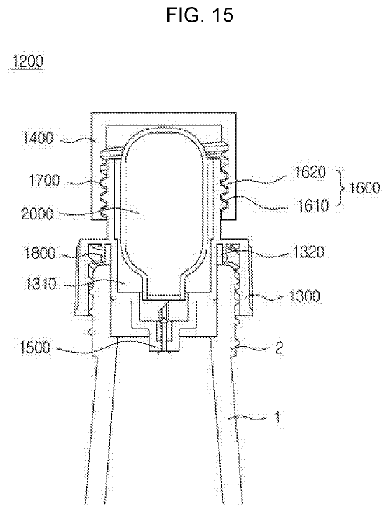

FIG. 15 illustrates a schematic view of a compressed gas supply device according to another exemplary embodiment of the present invention.

Referring to FIG. 15, an integral compressed gas supply device 1200 according to another exemplary embodiment of the present invention includes a body 1300, a cover 1400, a discharging means 1500, an operating means 1600, a recognizing means 1700, and a sealing jaw 1800.

The descriptions of the discharging means 1500, the recognizing means 1700, the sealing jaw 1800, and a gas container 2000 is the same as those described with reference to FIG. 2.

The body 1300 includes an accommodating space 1310 therein and an installation space 1320 at a lower portion thereof. The gas container 200 which contains a compressed gas, and then is closed by a stopper, is accommodated in the accommodating space 1310. In the installation space 1320, an opened inlet portion 2 of the food container 1 in which liquid is contained is installed.

The cover 1400 is provided to prevent escaping of the gas container 2000 accommodated in the accommodating space 1310 of the body 1300, to be coupled to the body 1300 by the operating means 1600.

The operating means 1600 includes a first operating thread 1610 and second operating thread 1620.

The first actuating thread 1610 is formed in the accommodating space 1310 of the body 1300 and the second operating thread 1620 is formed along the external circumference of the cover 1400 to correspond to the first operating thread 1610.

The operating means 1600 rotates the cover 1400 in any one direction such that the second operating thread 1620 is engaged with the first operating thread 1610.

As the operating means 1600 rotates, the cover 1400 pressurizes and moves the gas container 2000 downward such that the compressed gas of the gas container 2000 is discharged into the food container 1 by the discharging means 1500.

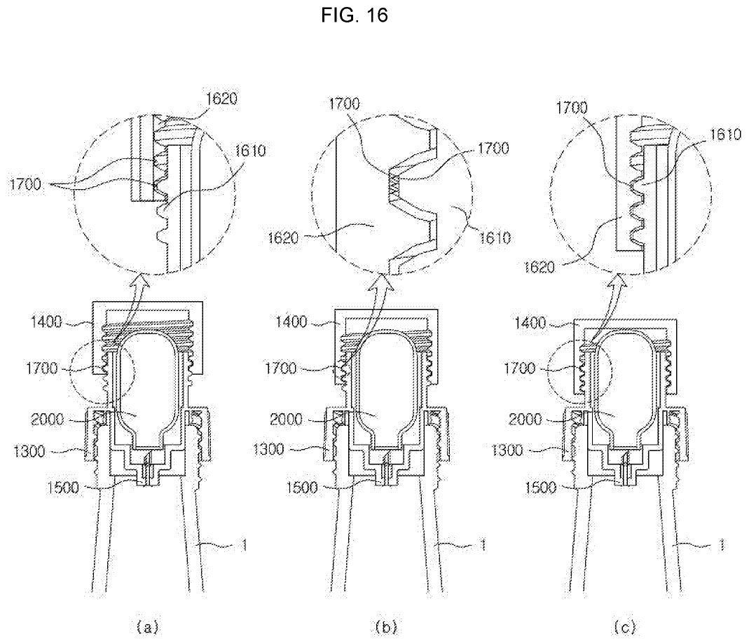

FIG. 16 illustrates an operation state of a recognizing means of a compressed gas supply device according to another exemplary embodiment of the present invention.

Referring to (a) in FIG. 16, (a) illustrates a state in which the gas container 2000 is accommodated in the accommodating space 1310 of the body 1300, and the cover 1400 is coupled to the body 1300.

In this state, the cover 1400 is not in contact with an upper portion of the gas container 2000, the gas container 2000 is not in contact with the discharging means 1500 due to the cover 200, and the first operating thread 1610 and the second operating thread 1620 are not engaged with each other.

Referring to (b) in FIG. 16, (b) illustrates a state in which the cover 1400 moves along the body 1300 by the operating means 1600 to contact the recognizing means 1700.

In this state, as the second operating thread 1620 moves in combination with the first operating thread 1610, the recognizing means 1700 formed in the first operating thread 1610 and the second operating thread 1620 contact each other, so that a user feels a vibration by the recognizing means 1700 to recognize that the gas container 2000 is in a state before being discharged by the discharging means 1500.

Referring to (c) in FIG. 16, (c) illustrates a state in which the cover 1400 moves along the body 1300 by the operating means 1600 to pressurize the gas container 2000 such that the compressed gas inside the gas container 2000 is discharged by the discharging means 1500.

In this state, the cover 1400 moves to the body 1300 through the recognizing means 1700 to pressurizes the gas container 2000, whereby the compressed gas inside the gas container 20 is discharged by the discharging means 1500.

The above descriptions are provided for illustrative purposes of the technical concepts of the present invention, and a person having ordinary skill in the art may understand that various other modifications or equivalents are possible without departing from the natural characteristics of the present invention

Consequently, the true technical protective scope of the present invention must be determined based on the technical spirit of the appended claims.

Description of Symbols

| | |
|---|---|
| 10: compressed gas supply device | 20: gas container |
| 100: body | 110: inner body |
| 120: outer body | 200: cover |
| 210: inner cover | 220: outer cover |
| 300: discharging means | 400: coupling means |
| 500: operating means | 600: recognizing means |
| 700: sealing jaw | |

1. A compressed gas supply device comprising:
a cover;
a body configured to accommodate a gas container containing a compressed gas therein and to be installed at an open inlet portion of a food container containing a liquid;
a discharging means provided in the body for discharging the compressed gas into the food container by opening the gas container;
a coupling means configured to couple the cover to the body; and
a sealing jaw formed in the body to prevent the liquid of the food container from being exhausted to the outside by contacting the inlet portion of the food container.

2. The compressed gas supply device of claim 1, wherein the body is formed with an installation space for positioning the inlet portion between the outer body and the inner body, and the sealing jaw is formed to protrude downward at an upper end of the installation space to come into contact with an upper end of the inlet portion.

3. The compressed gas supply device of claim 1 or 2, wherein the sealing jaw has elasticity.

4. A compressed gas supply device comprising:
a cover;
a body configured to accommodate a gas container containing a compressed gas therein and to be installed at an open inlet portion of a food container containing a liquid;
a discharging means provided in the body for discharging the compressed gas into the food container by opening the gas container;
an operating means configured to pressurize the gas container to be opened by the discharging means while moving the cover in a state being engaged with the body; and
a recognizing means provided in the operating means for confirming that the gas container is in a state before being opened by the discharging means,
wherein the recognizing means is a protrusion.

5. (canceled)

6. The compressed gas supply device of claim 4, further comprising:
an installation space provided in the body for positioning the inlet portion of the food container; and
a sealing jig configured to protrude downward from the upper end of the installation space and to have a length that varies depending on a length of the inlet portion to seal the inlet portion of the food container.

7. A compressed gas supply device comprising:
a cover;
a body configured to accommodate a gas container containing a compressed gas therein and to be installed at an open inlet portion of a food container containing a liquid;
a discharging means provided in the body for discharging the compressed gas into the food container by opening the gas container;
an operating means configured to pressurize the gas container to be opened by the discharging means while moving the cover in a state being engaged with the body;
an installation space provided in the body for positioning the inlet portion of the food container; and
a sealing jig configured to protrude downward from the upper end of the installation space and to have a length that varies depending on a length of the inlet portion to seal the inlet portion of the food container.

8. The compressed gas supply device of claim 6, wherein a spring is provided between the installation space and the sealing jaw.

9. The compressed gas supply device of claim 4 or 7, further comprising a check valve disposed inside the discharging means to allow a flow of the compressed gas in one direction from the gas container to the food container and to block a flow in an opposite direction.

10. The compressed gas supply device of claim 9, wherein the check valve includes:
a piston configured to open or close an injection hole and to move by a pressure difference between opposite ends; and
a guide portion configured to support the piston such that the piston can reciprocate toward the injection hole.

11. The compressed gas supply device of claim 10,
wherein the guide portion includes:
a first engagement member coupled to the piston; and
a second engagement member slidably engaged with the first engagement member,
wherein one of the first engagement member and the second engagement member is formed with a groove and the other is slidably inserted into the groove.

12. The compressed gas supply device of claim 4 or 7, further comprising a lighting unit coupled to a lower end of the discharging unit and responsive to a pressure of the discharged gas.

13. The compressed gas supply device of claim 6 or 7, wherein the sealing jaw and the body are in contact with and coupled to the inlet portion to withstand an internal pressure of the food container when the compressed gas is discharged into the food container.

14. The compressed gas supply device of claim 2, wherein the sealing jaw has elasticity.

15. The compressed gas supply device of claim 7, wherein a spring is provided between the installation space and the sealing jaw.

16. The compressed gas supply device of claim 7, further comprising a check valve disposed inside the discharging means to allow a flow of the compressed gas in one direction from the gas container to the food container and to block a flow in an opposite direction.

17. The compressed gas supply device of claim 16, wherein the check valve includes:
a piston configured to open or close an injection hole and to move by a pressure difference between opposite ends; and
a guide portion configured to support the piston such that the piston can reciprocate toward the injection hole.

18. The compressed gas supply device of claim 17,
wherein the guide portion includes:
a first engagement member coupled to the piston; and
a second engagement member slidably engaged with the first engagement member,
wherein one of the first engagement member and the second engagement member is formed with a groove and the other is slidably inserted into the groove.

19. The compressed gas supply device of claim 7, further comprising a lighting unit coupled to a lower end of the discharging unit and responsive to a pressure of the discharged gas.

20. The compressed gas supply device of claim 7, wherein the sealing jaw and the body are in contact with and coupled to the inlet portion to withstand an internal pressure of the food container when the compressed gas is discharged into the food container.
